(19) United States
(12) Patent Application Publication
(10) Pub. No.: US 2005/0146874 A1
(43) Pub. Date: Jul. 7, 2005

(54) Using organic light emitting diodes (OLEDs) in landscape lighting applications

(76) Inventors: Leonard Cech, Brighton, MI (US); Benit Trevino, Mayfield Heights, OH (US)

Correspondence Address: FAY, SHARPE, FAGAN, MINNICH & MCKEE, LLP, 1100 SUPERIOR AVENUE, SEVENTH FLOOR, CLEVELAND, OH, 44114, US

(21) Appl. No.: 10/751,157

(22) Filed: Jan. 2, 2004

(51) Int. Cl. F21V 33/00

(52) U.S. Cl. 362/253

(57) ABSTRACT

A landscape lighting assembly and directional lighting arrangement uses an organic light emitting diode (OLED) light source. The low cost and low power required to operate the OLEDs offer many features and benefits over prior arrangements. In addition, it provides high light output and desired spectral efficiencies, along with an extended life.

### FIELD OF THE INVENTION

This invention relates to a lighting assembly, and more particularly to low voltage solar technology platforms for lighting applications.

### BACKGROUND OF THE INVENTION

Presently, landscape lighting systems, and backlighting systems for signage, fall into one of two technology platforms. The first type is a low voltage system which includes a central step-down transformer unit that converts standard 120 VAC, 60 Hz power line input into a 12 volt signal. The transformer powers a series of lamp nodes that are wired in parallel to a central supply wire. The supply wire is typically buried in the ground. In some instances, a standard electromagnetic transformer merely steps the input voltage down while maintaining the same frequency. Other low voltage systems use an electronic transformer that not only steps the input voltage down to the desired 12 VAC operating range, but significantly increases the frequency (e.g., 50 KHz). Still other systems use an AC-DC converter to step the input voltage down to a 12 VDC signal. Thus, although an electromagnetic transformer is low cost, it has low efficiency, large size and increased weight. The electronic transformer, on the other hand, has a high cost, a medium efficiency, and a reduced size and weight. Last, the AC-DC converter is approximately medium cost with a high efficiency, but is of medium size and weight. These low voltage systems are summarized below:

| Type | Cost | Efficiency | Size/Weight |
|---|---|---|---|
| Electromagentic | low | low | high |
| Electronic | high | mid | low |
| AC-DC | mid | high | mid |

Both low voltage systems use halogen/incandescent and fluorescent light sources.

The second type of system is based on solar technology. These systems include stand alone units that are mounted in the ground, i.e., no wiring is required. Each unit is self-contained and includes a photovoltaic panel, rechargeable battery, driver circuit, and a light source (typically one or more LEDs or a fluorescent tube). In sunlight, the drive circuit and light source are disabled via a light sensor, while the photovoltaic panel provides recharging energy or current to the battery. Ultimately, the battery reaches its charge capacity. When ambient light falls below a predetermined threshold level, the drive circuit is enabled and the light source is powered. The drive circuit includes an ambient light level detector that interfaces with the light source supply circuit.

Typically, these light sources are driven by a DC or pulse-width modulated topology. The DC-type is low cost and has a high efficency. When driving an LED light source, though, the DC-type drive circuit has a low spectral efficiency and only a medium LED life. A pulse width modulated system, on the other hand, has a high cost and low efficiency, even though it results in high spectral efficiency and increased LED life. Thus, solar systems often use LED and fluorescent light sources because of the efficiency results. In addition, the size of the photovoltaic panels and the number of rechargeable batteries must also be minimized to provide a small profile. Thus, efficient, light sources that extend the overall ON time are preferred.

Light sources typically used in landscape lighting applications include fluorescent, halogen/incandescent, and LEDs. Although halogen/incandescent light sources are low cost, they require high input power providing a high range of light output, and have a low spectral efficiency and low life expectancy. LEDs, on the other hand, are of medium cost and require a low input power. Even though LEDs have an extended life, the light output is low and the spectral efficiency is only rated at a medium level. Fluorescent light sources have a high cost associated therewith, and a medium range of input power resulting in high light output, high spectral efficiency, but only a medium life.

In addition, fluorescent light sources often require complex drive circuit (ball) and perform poorly at low temperatures.

Thus, a need exists for improvements in low voltage and solar technology platforms for landscape and back lighting uses that address cost, input power, light output, spectral efficiency, life, shape, and color options.

### SUMMARY OF THE INVENTION

An improved lighting assembly includes a housing that receives an organic light emitting diode (OLED) light source and a power source for the OLED. A light transmissive portion of the housing permits light from the OLED to pass therethrough.

An optional diffuser interposed between the light source and the light transmissive portion of the housing diffuses the light for the end use.

In selected applications the light source uses a photovoltaic panel generating electrical energy from ambient light.

A reflector may also be incorporated into the assembly to direct light from the OLED through the diffuser.

Clearly, an OLED light source provides for low cost, low input power, high light output, high spectral efficiency, and an increased life, while also permitting the OLED to be conformed to various shapes and provide different color options.

Still other features and benefits will become apparent upon reading the following detailed description.

### BRIEF DESCRIPTION OF DRAWINGS

FIG. 1 is an elevational view of a first preferred embodiment of an area landscape light assembly.

FIG. 2 is a second preferred embodiment of area landscape light assembly.

FIG. 3 is a third preferred embodiment of area landscape light assembly.

FIG. 4 shows a preferred directional landscape light assembly.

### DETAILED DESCRIPTION OF THE INVENTION

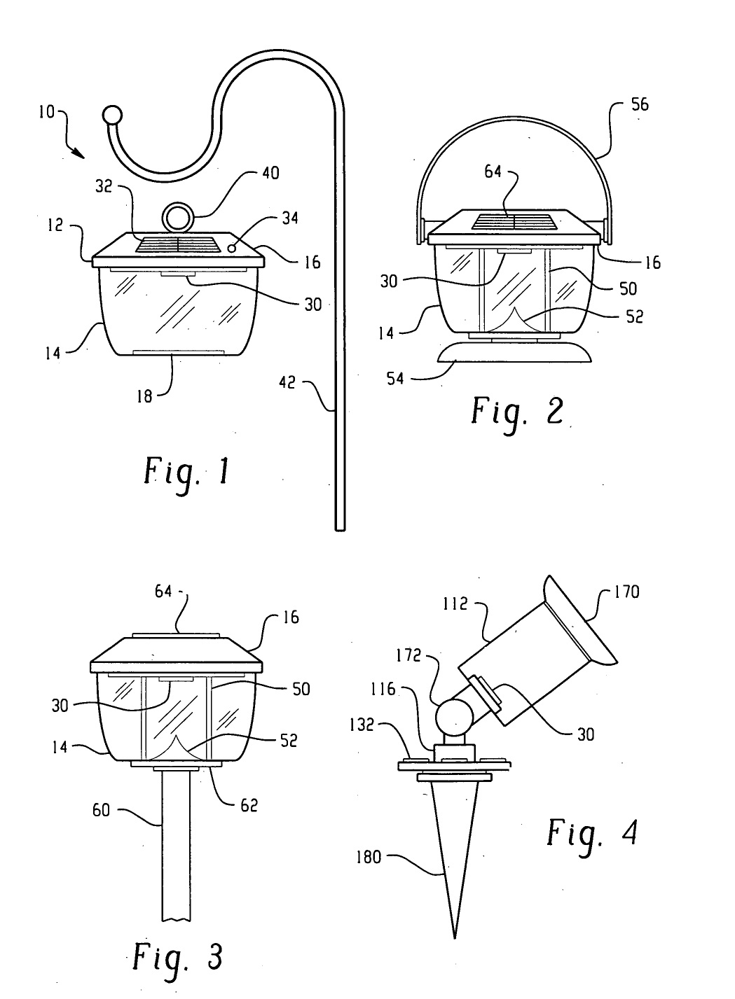

FIG. 1 illustrates a light assembly 10 particularly used for area landscape lighting. A housing 12 includes a light transmissive or clear lens portion 14 and a circuit housing portion 16. Typically, the light transmissive portion is a hollow chamber formed of a transparent plastic or similar material and may include a diffuser 18. Here, the diffuser 18 is disposed along a lower planar surface of the housing so that light emanating from the light source is generally evenly spread over the ground surface. The light source 30 is an organic light emitting diode (OLED). The OLED is preferably located at the other end of the transparent housing portion, particularly, the OLED is secured to a lower surface or underside of the circuit housing.

A power source is housed within the housing and is preferably an electronic transformer that receives electrical energy from a photovoltaic panel 32. One or more panels may be provided on an upper surface of the circuit housing portion where they are exposed to sunlight and provide electrical energy for recharging a battery associated with the power supply. In addition, a light sensor 34 disconnects the power source/battery from the OLED during daylight and allows the OLED to be powered during low ambient light conditions. A hanging element such as loop or ring 40 is provided on the housing so that it may be hung from a support member such as a shepherd's crook 42.

FIGS. 2 and 3 illustrate the preferred area landscape light assemblies that have many of the features described in association with FIG. 1. Accordingly, like reference numerals will refer to like components and new reference numerals will identify new components. In FIG. 2, diffuser 50 is a substantially hollow cylinder that extends within the transparent housing portion from a first or upper end adjacent the OLED light source 30 to a second or lower end. Also received within the transparent housing portion, and particularly within the diffuser, is a reflector 52. The reflector directs light emanating from the OLED to a desired output direction. In this embodiment, the reflector directs light from the OLED radially outward through the diffuser and ultimately through the transparent housing portion. A base 54 allows the light assembly to be set on a planar surface and handle 56 permits the light assembly to be transported like a lantern.

In the preferred embodiment of FIG. 3 the same diffuser and reflector assembly as described with respect to FIG. 2 is used. However, since it is not desired that light be directed through a bottom surface of the transparent housing portion, a mounting stake 60 supports a lower surface 62 of the housing. This allows the upper surface of the circuit housing to receive an enlarged photovoltaic panel 64 thereon.

It will also be appreciated that although photovoltaic versions of the OLED landscape light assembly are illustrated, removal of the panels and substitution of wiring interconnecting the light assembly with an external power source could also be used.

In FIG. 4 a preferred directional landscape light assembly is shown. Housing 112 encloses an OLED light source 130 and directs light through a protective lens 170; The direction of the housing may be varied through an angle socket joint 172, such as a ball socket, that allows selective orientation of the light source housing 112 relative to the circuit housing 116. Photovoltaic panels 132 are disposed along the circuit housing and oriented to maximize receipt of the sunlight. A stake extends from a lower portion of the circuit housing to secure the light assembly in place.

OLEDs have a major advantage over other lighting sources in that OLEDs can be fabricated into flexible, thin-film sheets. These sheets are used to create unique shapes and mounting methods for light emitting surfaces. This, in turn, reduces the need for diffusers and light guides that typically are used in incandescent, fluorescent, and LED outdoor lighting products. The OLEDs are be designed to supply light output comparable to either LEDs or halogen/incandescent systems. Thus, for low light output applications (ambient or area lighting), a solar technology system can be used. Conversely, for high light output applications (directional lighting), a low voltage driving system can be used (FIG. 4). Thus, integrating OLEDs into landscape lighting applications provides a low cost, low input power assembly that has a high light output rating, along with a high spectral efficiency and extended life expectancy. The ability to shape the OLED also offers many advantages over the known light sources.

In addition, color options are viable alternatives and may be used to create pixel displays leading to light emitting OLED panels with multi-color capability. In such an arrangement, a microcontroller drives the OLED pixel elements in a manner to vary color in a predetermined fashion for coloring effects, such as holiday lighting.

The invention has been described with reference to an illustrative embodiment. Obviously, modifications and alterations will occur to others upon reading and understanding of the preceding detailed description. It is intended that the invention be construed as including all such alterations and modifications insofar as they come within the scope of the appended claims or the equivalents thereof.

1. A lighting assembly comprising:
a housing;
an organic light emitting diode (OLED) light source mounted in the housing;
a power source for the OLED; and
a light transmissive portion of the housing allowing light from the OLED light source to pass therethrough.

2. The lighting assembly of claim 1 further comprising a diffuser interposed between the OLED light source and the light transmissive portion for diffusing the light received from the OLED.

3. The lighting assembly of claim 1 wherein the power source further includes a photovoltaic panel for generating electrical energy from ambient light.

4. The lighting assembly of claim 1 wherein the power source includes a light sensor for selectively disconnecting the power source with the OLED in response to a predetermined level of ambient light.

5. The lighting assembly of claim 1 further comprising a reflector for directing light from the OLED light source toward the light transmissive portion of the housing.

6. The lighting assembly of claim 1 further comprising a reflector for directing light from the OLED light source toward a diffuser interposed between the OLED light source and the light transmissive portion.

7. The lighting assembly of claim 1 wherein the diffuser is a hollow cylinder enclosing the OLED.

8. The lighting assembly of claim 7 wherein the OLED is located at first end of the cylinder and a reflector is located at a second end thereof.

9. The lighting assembly of claim 1 wherein the OLED is located at a first end of the housing and a diffuser is located at a second end of the housing.

10. The lighting assembly of claim 1 wherein the power source includes a photovoltaic panel for generating electrical energy from ambient light and providing low voltage on the order of 12 volts for outdoor landscape lighting.

11. The lighting assembly of claim 10 further comprising a rechargeable battery that is selectively charged by the photovoltaic panel and a light sensor that selectively connects the power source with the OLED in response to a predetermined level of ambient light.

12. An outdoor landscape lighting assembly comprising:
a housing;
an organic light emitting diode (OLED) light source mounted in the housing and sealed from the external environment;
a low power source for the OLED including a photovoltaic panel for selectively charging a rechargeable battery; and
a light transmissive portion of the housing allowing light from the OLED light source to pass therethrough.

13. The outdoor landscape lighting assembly of claim 12 further comprising a diffuser interposed between the OLED light source and the light transmissive portion for diffusing the light received from the OLED.

14. The outdoor landscape lighting assembly of claim 12 wherein the power source includes a light sensor for selectively disconnecting the power source with the OLED in response to a predetermined level of ambient light.

15. The outdoor landscape lighting assembly of claim 12 further comprising a reflector for directing light from the OLED light source toward a diffuser interposed between the OLED light source and the light transmissive portion.

16. The outdoor landscape lighting assembly of claim 12 wherein the diffuser is a hollow cylinder enclosing the OLED.

17. The outdoor landscape lighting assembly of claim 16 wherein the OLED is located at first end of the cylinder and a reflector is located at a second end thereof.

18. The outdoor landscape lighting assembly of claim 12 wherein the OLED is located at a first end of the housing and a diffuser is located at a second end of the housing.
